(19) United States
(12) Patent Application Publication
(10) Pub. No.: US 2018/0199383 A1
(43) Pub. Date: Jul. 12, 2018

(54) Methods and Systems for Delivering Messages via Multiple Communication Channels

(71) Applicant: Siu Ho Au Yeung, Hong Kong (HK)

(72) Inventor: Siu Ho Au Yeung, Hong Kong (HK)

(21) Appl. No.: 15/401,119

(22) Filed: Jan. 9, 2017

(51) Int. Cl. H04W 76/02; H04W 4/14; H04L 29/08; H04W 12/06; H04W 4/00

(52) U.S. Cl. CPC H04W 76/025; H04W 4/14; H04W 4/001; H04W 12/06; H04L 67/26

(57) ABSTRACT

According to embodiments of the disclosed technology, systems and methods are provided for a mobile gateway I.T. system that is configured to receive a message from a source for transmission to a destination and multiple varying communication channels on which to transmit the message to the destination. The system may use a logic control library that is tightly coupled to the mobile gateway and the communication channels. The logic control library may be configured to select a first communication channel from the communication channels to route the message for transmission to the destination. The logic control library may be further configured to select a second communication channel from the communication channels to route the message for transmission to the destination in response to a period of time expiring without receiving a confirmation protocol from the destination via the first communication channel.

### FIELD OF THE INVENTION

The presently disclosed technology generally relates to communication systems, and more specifically to employing different communication channels to ensure proper delivery and receipt of electronic messages.

### BACKGROUND OF THE DISCLOSED TECHNOLOGY

The advent of the Internet has profoundly changed the way we communicate. Electronic communications has many shapes and forms. From emails to text messages, to social networking messaging platforms, to video chatting, the way humans communicate is forever evolving. However, the existence of this multitude of communication channels has had some negative effects. One such effect, for example, is that a user may skip over an important message in delving through the abundance of messages received in a single day. Important emails may get lost amongst a plethora of SPAM or other advertising emails. Likewise, full mailbox or incorrect email addresses may lead to messages not reaching their intended reader.

As a general example, one entity may send a message to another entity for delivery by a designated type of single communication channel. Using a single communication channel for delivery of the message may have an increased risk of the message not being delivered or not being delivered timely (i.e., being delivered late), for example, due to any incident along the delivery chain. It may be market demand to develop systems and techniques for more reliable delivery of messages, particularly in view of the mobile systems where communication with handsets are prevalent.

Accordingly, there is a demand for a communications system which transmits a single message via various channels employing various modes of electronic communication.

### SUMMARY OF THE INVENTION

According to embodiments of the disclosed technology, systems and methods are provided for a mobile gateway I.T. system that is configured to receive a message from a source for transmission to a destination and multiple varying communication channels on which to transmit the message to the destination. The system may use a logic control library that is tightly coupled to the mobile gateway and the communication channels. The logic control library may be configured to select a first communication channel from the communication channels to route the message for transmission to the destination. The logic control library may be further configured to select a second communication channel from the communication channels to route the message for transmission to the destination in response to a period of time expiring without receiving a confirmation protocol from the destination via the first communication channel.

In one embodiment, a first communication channel may include a socket-based, web-socket communication channel that may provide push message or push notifications to the destination. The socket-based communication channel may include features to provide message transmission delivery to the destination. One feature of the socket-based communication channel is that there may be a unique, secure channel established between the intermediary and the destination. The secure channel may be established using a channel identifier, which is a shared entity between the intermediary and the destination designation.

For the intermediary, the unique channel identifier may be stored for use in a storage means. The storage means may store the channel identifier in a database or table, for instance, along with information that associates the unique channel identifier with the particular destination such as a destination identifier that can be used as part of a searching when sending messages to the specific destination. If the device is a mobile device, the information may include a mobile phone number that is stored in the storage means and associated with the specific destination.

The mobile phone number may be collected by the intermediary as part of a registration step with the destination. The information may be stored along with information needed to communicate with the destination using the other communication channels, including the channel identifier for socket-based communications.

The communication information associated with a particular destination may be part of a destination profile that is stored in the storage means in a database, table or other storage means that enables a look up of the information for use in delivery of messages to the destination.

Assuming the intermediary first attempts to deliver the message using the socket-based communication channel and no acknowledgement is received from the destination within a period of time, then the intermediary may send the message using the short messaging communication channel. In this manner, the source has the benefit of multiple channels of communication to the destination through the intermediary, where the source only needs to transmit the message one time. The intermediary part then processes the message for routing including using multiple different communication channels to transmit the message to the destination

Referring now to specific embodiments of the disclosed technology, a system is provided for sending messages via multiple communication channels. The system may employ one or more of the following components: a) a gateway that is configured to receive a message from a source for transmission to a destination; b) a plurality of communication channels on which to transmit the message to the destination, wherein the plurality of communication channels include different types of communication channels; and/or c) a logic control library that is operably coupled to the gateway and the plurality of communication channels.

The logic control library may be configured to select a first communication channel from the plurality of communication channels to route the message for transmission to the destination, and select a second communication channel from the plurality of communication channels to route the message for transmission to the destination in response to a period of time expiring without receiving a handshaking protocol from the destination via the first communication channel. The second communication channel may be a different type of communication channel than the first communication channel, in that the first communication channel includes a secure connection between the first communication channel and the destination using a unique channel. The logic control library may have a storage module for storing routing information that is unique to the destination for at least the first communication channel and the second communication channel. The routing information is different for the first communication channel and the second communication channel.

In embodiments, the logic control library may also be configured to do one or more of the following: a) determine if a connection is active between the first communication channel and the destination prior to selecting the first communication channel; b) select the first communication channel to route the message for transmission to the destination if the connection is active; and/or c) select the second communication channel to route the message for transmission to the destination if the connection is not active.

In a further embodiment, the destination may be a mobile device. The message may be data that is a portion of a two-factor authentication between the source and the mobile device. The portion of the two-factor authentication may be a one-time artifact transmitted from the source to the mobile device. The first communication channel may have a secure data connection between the first communication channel and a mobile application running on the mobile device. The message may be transmitted to the mobile application on the mobile device as an in-application message using the first communication channel.

In still another embodiment of the disclosed technology, a computer-implemented method is provided for executing instructions stored on a non-transitory computer-readable storage medium. The method may be carried out, not necessarily in the following order, by: a) receiving a message from a source for transmission to a destination; selecting a first communication channel from a plurality of communication channels to route the message for transmission to the destination, wherein the plurality of communication channels include different types of communication channels, and selecting a second communication channel from the plurality of communication channels to route the message for transmission to the destination in response to a period of time expiring without receiving an handshaking protocol from the destination via the first communication channel, wherein the second communication channel is a different type of communication channel than the first communication channel; b) determining if a connection is active between the first communication channel and the destination prior to selecting the first communication channel; c) selecting the first communication channel to route the message for transmission to the destination if the connection is active; d) selecting the second communication channel to route the message for transmission to the destination if the connection is not active; e) determining if the first communication channel is a preferred communication channel based on a communication channel preference received from the destination; and/or f) selecting the first communication channel to route the message for transmission to the destination if the first communication channel is the preferred communication channel, the destination is a mobile device, the first communication channel is a socket-based communication channel and the second communication channel is a short message service (SMS) communication channel.

One or more additional steps may be carried out, not necessarily in the following order, by: a) establishing a unique channel with the mobile device to use with the socket-based communication channel; receiving a mobile phone number for the mobile device during a registration process; and b) storing information for the unique channel and the mobile phone number in a storage module for use when routing communications using the socket-based communication channel and the SMS communication channel, respectively, the message is data that is a portion of a two-factor authentication between the source and the mobile device, and wherein the portion of the two-factor authentication is a one-time artifact transmitted from the source to the mobile device.

In a further embodiment, a system is provided having one or more of the following components: a) a gateway that is configured to receive a message from a source for transmission to a mobile device running a mobile application; b) at least two communication channels on which to transmit the message to the mobile device including a web-socket communication channel and a second communication channel that is different than the web-socket communication channel; and c) a logic control library that is operably coupled to the gateway and the at least two communication channels, wherein the logic control library comprises a storage module for storing routing information that is unique to the mobile device for the web-socket communication channel and the second communication channel, wherein the routing information is different for the web-socket communication channel and the second communication channel.

The logic control library may be configured to: i) determine if a connection is active between the web-socket communication channel and the mobile device prior to selecting the web-socket communication channel; ii) select the web-socket communication channel to route the message for transmission to the mobile device if the connection is active; iii) select the second communication channel to route the message for transmission to the mobile device if the connection is not active; and/or iv) if the message was first transmitted using the web-socket communication channel, select the second communication channel to route the message for transmission to the mobile device in response to a period of time expiring without receiving an handshaking protocol from the mobile device via the web-socket communication channel.

The second communication channel may be, for example, a short message service (SMS) communication channel. The message may be data that is a one-time artifact for a two-factor authentication between the source and the mobile device.

A better understanding of the disclosed technology will be obtained from the following brief description of drawings illustrating exemplary embodiments of the disclosed technology.

### BRIEF DESCRIPTION OF THE DRAWINGS

FIG. 1 shows an overview generalizing operation of the lighting system according to embodiments of the disclosed technology.

FIG. 2 shows a flow chart outlining operational steps for the transmission of data according to embodiments of the disclosed technology.

FIG. 3 is a flow chart outlining steps of a message sending method according to embodiments of the disclosed technology.

A better understanding of the disclosed technology will be obtained from the following detailed description of embodiments of the disclosed technology, taken in conjunction with the drawings.

### DETAILED DESCRIPTION OF EMBODIMENTS OF THE DISCLOSED TECHNOLOGY

References will now be made in detail to the present exemplary embodiments, examples of which are illustrated in the accompanying drawings. Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness.

According to embodiments of the disclosed technology, systems and methods are provided for a mobile gateway I.T. system that is configured to receive a message from a source for transmission to a destination and multiple varying communication channels on which to transmit the message to the destination. The system may use a logic control library that is tightly coupled to the mobile gateway and the communication channels. The logic control library may be configured to select a first communication channel from the communication channels to route the message for transmission to the destination. The logic control library may be further configured to select a second communication channel from the communication channels to route the message for transmission to the destination in response to a period of time expiring without receiving a confirmation protocol from the destination via the first communication channel.

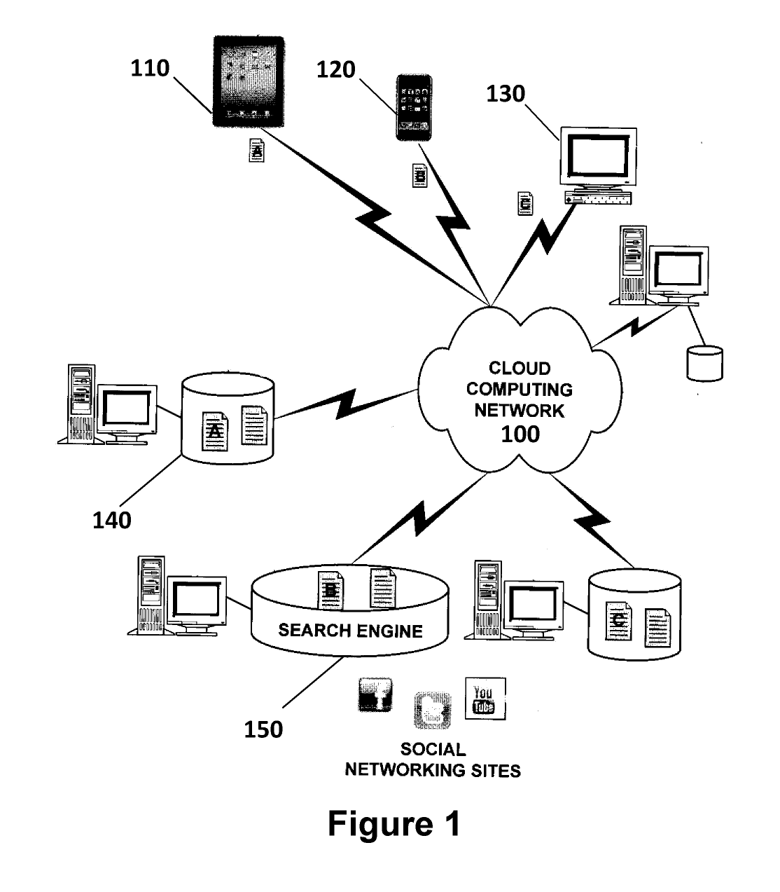

Referring now to the drawings, FIG. 1 shows an overview generalizing operation of the communication system according to embodiments of the disclosed technology. The central node of the system is a cloud computing network 100 (also referred to as “Cloud”) which is an Internet based computing system which provides shared computer processing resources and data to computers and other devices on demand. A plurality of devices may connect to the Cloud 100 via readily available network communication channels. Such a data repository may be accessible by any device having internet connectivity via any network. The data may be processed, encrypted and/or decrypted at the node. From the central repository, data may be sent and received to/from multiple access points.

Connectivity to the Cloud 100 may be carried out using any electronic computing device, such as, for example, a mobile phone 120, tablet 110, laptop computer, desktop computer 130, smart TV, smart TV adapter, MP3 player and/or any other computing device with network connectivity. A search engine 150 or other web-based interface 140 may act as an intermediary node between a computer 140 and the cloud 100. Communication may also be carried out using an application installed on the computing devices. The application may be a mobile software application operable on any mobile computing operating system, such as, Windows, Android, iOS, Linux, OS X, BSD, QNX, etc. The application may be available to any users having access to an application database associated with his or her computing device.

Messages and data may be transmitted back and forth between the computing devices and the Cloud 100. A wireless local area network (e.g. Wi-Fi), a packet-switched data network, near-field communication, Bluetooth, and/or any other wireless data transferring means may be used to communicate with mobile devices. Examples of Bluetooth technologies (using the 2.4 GHz band as WiFi) that may be incorporated into the disclosed technology are the RN-4.1 Bluetooth modules, KC-41, KC 11.4, KC-5100, KC-216 or KC-225 data serial modules, and/or a BT-21 module. Examples of wireless network protocols that may be employed by the disclosed technology include, but are not limited to, the IEEE 802.11a, IEEE 802.11b, IEEE 802.11g and IEEE 802.11n modulation techniques. Applicants recognize that there are numerous wireless protocols that have been developed that, although not specifically listed, could be utilized with the present invention for data transfer purposes.

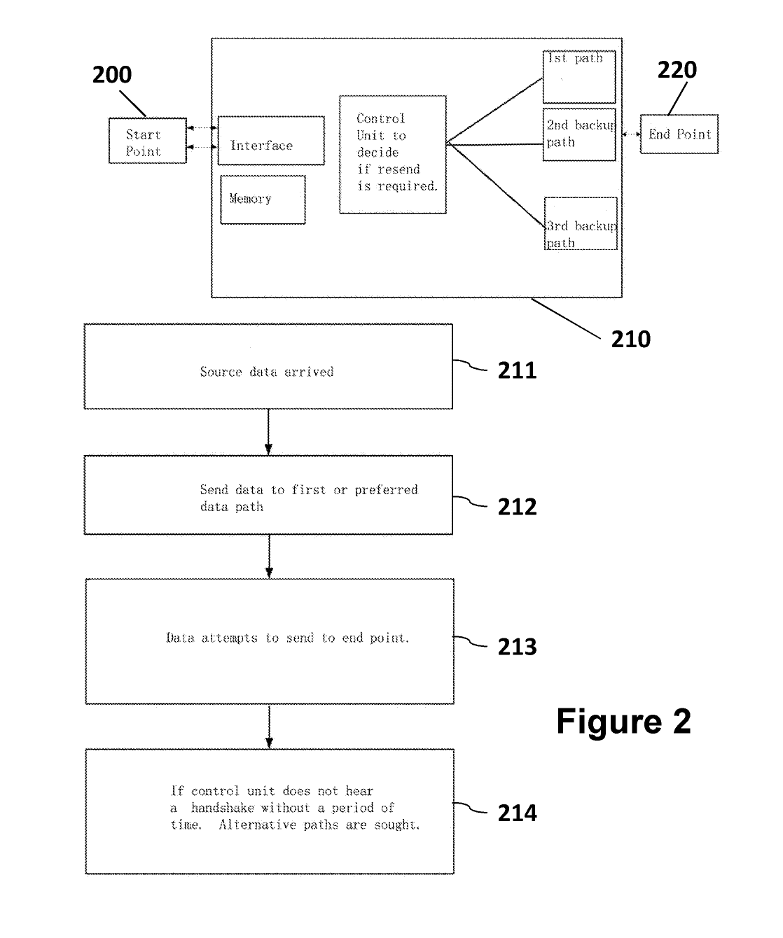

FIG. 2 shows a flow chart outlining operational steps for the transmission of data according to embodiments of the disclosed technology. In one embodiment, a first communication channel may include a socket-based, web-socket communication channel that may provide push message or push notifications to the destination. The socket-based communication channel may include features to provide message transmission delivery to the destination. One feature of the socket-based communication channel is that there may be a unique, secure channel established between the intermediary and the destination. The secure channel may be established using a channel identifier, which is a shared entity between the intermediary and the destination designation.

For the intermediary, the unique channel identifier may be stored for use in a storage means. The storage means may store the channel identifier in a database or table, for instance, along with information that associates the unique channel identifier with the particular destination such as a destination identifier that can be used as part of a searching when sending messages to the specific destination. If the device is a mobile device, the information may include a mobile phone number that is stored in the storage means and associated with the specific destination.

The mobile phone number may be collected by the intermediary as part of a registration step with the destination. The information may be stored along with information needed to communicate with the destination using the other communication channels, including the channel identifier for socket-based communications.

The communication information associated with a particular destination may be part of a destination profile that is stored in the storage means in a database, table or other storage means that enables a look up of the information for use in delivery of messages to the destination.

Assuming the intermediary first attempts to deliver the message using the socket-based communication channel and no acknowledgement is received from the destination within a period of time, then the intermediary may send the message using the short messaging communication channel. In this manner, the source has the benefit of multiple channels of communication to the destination through the intermediary, where the source only needs to transmit the message one time. The intermediary part then processes the message for routing including using multiple different communication channels to transmit the message to the destination.

Referring still to FIG. 2, the transmission of a message begins with a start point 200, which may be any device described with respect to FIG. 1. The message is sent via an interface 210 which may be cloud-based. The interface 210 may determine the proper channels and paths that the message may take in order to reach its intended recipient, end point 220.

The interface 210 may take certain steps to facilitate delivery of the message to its intended recipient. In step 211, the source data arrives via the interface. In step 212, an attempt is made to send the data along a first data path. The first data path may be a pre-designated preferred data path. This may be changeable based on what is the most reliable path. As the message progresses, in step 213 at attempt is made to deliver the message to the end point 220. Finally, in step 214, if no confirmation or handshake is received after a designated time period, alternative paths are sought.

Referring now to specific embodiments of the disclosed technology, a system is provided for sending messages via multiple communication channels. The system may employ one or more of the following components: a) a gateway that is configured to receive a message from a source for transmission to a destination; b) a plurality of communication channels on which to transmit the message to the destination, wherein the plurality of communication channels include different types of communication channels; and/or c) a logic control library that is operably coupled to the gateway and the plurality of communication channels.

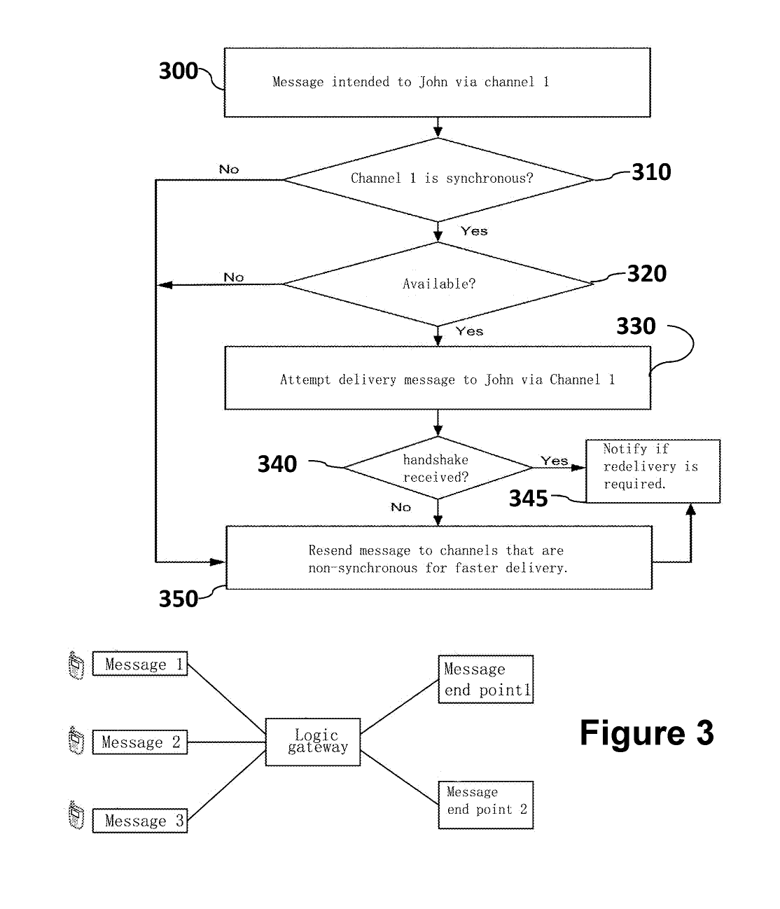

FIG. 3 is a flow chart outlining steps of a message sending method according to embodiments of the disclosed technology. These are the steps, as they are carried out with respect to a message being transmitted via a logic gateway. In step 300, the logic control library may be configured to select a first communication channel from the plurality of communication channels to route the message for transmission to the destination, and select a second communication channel from the plurality of communication channels to route the message for transmission to the destination in response to a period of time expiring without receiving a handshaking protocol from the destination via the first communication channel. The second communication channel may be a different type of communication channel than the first communication channel, in that the first communication channel includes a secure connection between the first communication channel and the destination using a unique channel. The logic control library may have a storage module for storing routing information that is unique to the destination for at least the first communication channel and the second communication channel. The routing information is different for the first communication channel and the second communication channel.

In embodiments, the logic control library may also be configured to do one or more of the following: a) in step 310, determine if a connection is active between the first communication channel and the destination prior to selecting the first communication channel; b) in step 320, select the first communication channel to route the message for transmission to the destination if the connection is active; and/or c) select the second communication channel to route the message for transmission to the destination if the connection is not active. If channel 1 is available, in step 330, delivery is attempted via the first channel. In step 340, it is determined if a handshake is received from the recipient. The handshake, may be any sort of confirmation or receipt that would indicate to the sender that the message was properly transmitted. If the handshake is received, a notification may be sent regarding redelivery in step 345. Otherwise, if the message isn't sent, in step 350, the message is resent to channels that are non-synchronous for faster delivery.

In a further embodiment, the destination may be a mobile device. The message may be data that is a portion of a two-factor authentication between the source and the mobile device. The portion of the two-factor authentication may be a one-time artifact transmitted from the source to the mobile device. The first communication channel may have a secure data connection between the first communication channel and a mobile application running on the mobile device. The message may be transmitted to the mobile application on the mobile device as an in-application message using the first communication channel.

In still another embodiment of the disclosed technology, a computer-implemented method is provided for executing instructions stored on a non-transitory computer-readable storage medium. The method may be carried out, not necessarily in the following order, by: a) receiving a message from a source for transmission to a destination; selecting a first communication channel from a plurality of communication channels to route the message for transmission to the destination, wherein the plurality of communication channels include different types of communication channels, and selecting a second communication channel from the plurality of communication channels to route the message for transmission to the destination in response to a period of time expiring without receiving an handshaking protocol from the destination via the first communication channel, wherein the second communication channel is a different type of communication channel than the first communication channel; b) determining if a connection is active between the first communication channel and the destination prior to selecting the first communication channel; c) selecting the first communication channel to route the message for transmission to the destination if the connection is active; d) selecting the second communication channel to route the message for transmission to the destination if the connection is not active; e) determining if the first communication channel is a preferred communication channel based on a communication channel preference received from the destination; and/or f) selecting the first communication channel to route the message for transmission to the destination if the first communication channel is the preferred communication channel, the destination is a mobile device, the first communication channel is a socket-based communication channel and the second communication channel is a short message service (SMS) communication channel.

One or more additional steps may be carried out, not necessarily in the following order, by: a) establishing a unique channel with the mobile device to use with the socket-based communication channel; receiving a mobile phone number for the mobile device during a registration process; and b) storing information for the unique channel and the mobile phone number in a storage module for use when routing communications using the socket-based communication channel and the SMS communication channel, respectively, the message is data that is a portion of a two-factor authentication between the source and the mobile device, and wherein the portion of the two-factor authentication is a one-time artifact transmitted from the source to the mobile device.

In a further embodiment, a system is provided having one or more of the following components: a) a gateway that is configured to receive a message from a source for transmission to a mobile device running a mobile application; b) at least two communication channels on which to transmit the message to the mobile device including a web-socket communication channel and a second communication channel that is different than the web-socket communication channel; and c) a logic control library that is operably coupled to the gateway and the at least two communication channels, wherein the logic control library comprises a storage module for storing routing information that is unique to the mobile device for the web-socket communication channel and the second communication channel, wherein the routing information is different for the web-socket communication channel and the second communication channel.

The logic control library may be configured to: i) determine if a connection is active between the web-socket communication channel and the mobile device prior to selecting the web-socket communication channel; ii) select the web-socket communication channel to route the message for transmission to the mobile device if the connection is active; iii) select the second communication channel to route the message for transmission to the mobile device if the connection is not active; and/or iv) if the message was first transmitted using the web-socket communication channel, select the second communication channel to route the message for transmission to the mobile device in response to a period of time expiring without receiving an handshaking protocol from the mobile device via the web-socket communication channel.

The second communication channel may be, for example, a short message service communication channel. The message may be data that is a one-time artifact for a two-factor authentication between the source and the mobile device

Any pertinent claims, description, and drawings of this application may describe one or more of the instant technologies in operational/functional language, for example as a set of operations to be performed by a computer, CPU, and/or processor. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail above, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language, or tools in the form of Very high speed Hardware Description Language (which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid, quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors).

The logic circuits forming the microprocessor are arranged to provide a microarchitecture that will carry out the instructions defined by that microprocessors defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long.

It is significant here that, although the machine language instructions are written as sequences of binary digits, in actuality those binary digits specify physical reality. For example, if certain semiconductors are used to make the operations of Boolean logic a physical reality, the apparently mathematical bits 1 and 0 in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendors piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand apply in a manner independent of a specific vendor's hardware implementation.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the specification and any future claims are to be embraced within their scope. Combinations of any of the methods, systems, and devices described hereinabove are also contemplated and within the scope of the invention. Accordingly, the foregoing description should not be read as pertaining only to the precise structures described and shown in the accompanying drawings, but rather should be read as consistent with and as support for any claims which may be appended to any application claiming priority to the present application, which are to have their fullest and fairest scope.

Although exemplary systems and methods are described in language specific to structural features and/or methodological acts, the subject matter defined in the future claims is not necessarily limited to the specific features or acts described. Rather, the specific features and acts are disclosed as exemplary forms of implementing the claimed systems, methods, and structures.

Moreover, means-plus-function clauses in the future claims cover the structures described herein as performing the recited function and not only structural equivalents but also equivalent structures. Thus, a nail and a screw may not be structural equivalents because a nail employs a cylindrical surface to secure parts together and a screw employs a helical surface, but in the environment of fastening parts, a nail may be the equivalent structure to a screw. Applicant expressly intends to not invoke 35 U.S.C. § 112, paragraph 6, for any of the limitations of the claims herein except for claims which explicitly use the words “means for” with a function.

What is claimed:

1. A system, comprising:
a gateway that is configured to receive a message from a source for transmission to a destination;
a plurality of communication channels on which to transmit the message to the destination, wherein the plurality of communication channels include different types of communication channels; and
a logic control library that is operably coupled to the gateway and the plurality of communication channels, wherein the logic control library is configured to:
select a first communication channel from the plurality of communication channels to route the message for transmission to the destination, and select a second communication channel from the plurality of communication channels to route the message for transmission to the destination in response to a period of time expiring without receiving a handshaking protocol from the destination via the first communication channel, wherein the second communication channel is a different type of communication channel than the first communication channel, wherein the first communication channel includes a secure connection between the first communication channel and the destination using a unique channel, wherein the logic control library comprises a storage module for storing routing information that is unique to the destination for at least the first communication channel and the second communication channel, wherein the routing information is different for the first communication channel and the second communication channel.

2. The system of claim 1, wherein the logic control library is further configured to:
determine if a connection is active between the first communication channel and the destination prior to selecting the first communication channel;
select the first communication channel to route the message for transmission to the destination if the connection is active; and
select the second communication channel to route the message for transmission to the destination if the connection is not active.

3. The system of claim 2, wherein the destination is a mobile device, the message is data that is a portion of a two-factor authentication between the source and the mobile device, the portion of the two-factor authentication is a one-time artifact transmitted from the source to the mobile device, the first communication channel includes a secure data connection between the first communication channel and a mobile application running on the mobile device, and wherein the message is transmitted to the mobile application on the mobile device as an in-application message using the first communication channel.

4. A computer-implemented method for executing instructions stored on a non-transitory computer-readable storage medium, the method comprising:
receiving a message from a source for transmission to a destination; selecting a first communication channel from a plurality of communication channels to route the message for transmission to the destination, wherein the plurality of communication channels include different types of communication channels, and selecting a second communication channel from the plurality of communication channels to route the message for transmission to the destination in response to a period of time expiring without receiving an handshaking protocol from the destination via the first communication channel, wherein the second communication channel is a different type of communication channel than the first communication channel;
determining if a connection is active between the first communication channel and the destination prior to selecting the first communication channel;
selecting the first communication channel to route the message for transmission to the destination if the connection is active;
selecting the second communication channel to route the message for transmission to the destination if the connection is not active;
determining if the first communication channel is a preferred communication channel based on a communication channel preference received from the destination; and
selecting the first communication channel to route the message for transmission to the destination if the first communication channel is the preferred communication channel, the destination is a mobile device, the first communication channel is a socket-based communication channel and the second communication channel is a short message service (SMS) communication channel.

5. The computer-implemented method of claim 4 further comprising:
establishing a unique channel with the mobile device to use with the socket-based communication channel; receiving a mobile phone number for the mobile device during a registration process; and
storing information for the unique channel and the mobile phone number in a storage module for use when routing communications using the socket-based communication channel and the SMS communication channel, respectively, the message is data that is a portion of a two-factor authentication between the source and the mobile device, and wherein the portion of the two-factor authentication is a one-time artifact transmitted from the source to the mobile device.

6. A system, comprising:
a gateway that is configured to receive a message from a source for transmission to a mobile device running a mobile application;
at least two communication channels on which to transmit the message to the mobile device including a web-socket communication channel and a second communication channel that is different than the web-socket communication channel; and
a logic control library that is operably coupled to the gateway and the at least two communication channels, wherein the logic control library comprises a storage module for storing routing information that is unique to the mobile device for the web-socket communication channel and the second communication channel, wherein the routing information is different for the web-socket communication channel and the second communication channel, wherein the logic control library is configured to:
determine if a connection is active between the web-socket communication channel and the mobile device prior to selecting the web-socket communication channel;
select the web-socket communication channel to route the message for transmission to the mobile device if the connection is active;
select the second communication channel to route the message for transmission to the mobile device if the connection is not active; and
if the message was first transmitted using the web-socket communication channel, select the second communication channel to route the message for transmission to the mobile device in response to a period of time expiring without receiving an handshaking protocol from the mobile device via the web-socket communication channel.

7. The system of claim 6 wherein the second communication channel is a short message service (SMS) communication channel.

8. The system of claim 7 wherein the message is data that is a one-time artifact for a two-factor authentication between the source and the mobile device.
